(19) United States
(12) Patent Application Publication
(10) Pub. No.: US 2014/0119046 A1
(43) Pub. Date: May 1, 2014

(54) Arrangement for light balancing

(71) Applicants: Ralph Kurt, Eindhoven (NL); Stefan Marcus Verbrugh, Eindhoven (NL); Jorrit Ernst De Vries, Culemborg (NL); Henricus Marius Joseph Maria Kahlman, Dongen (NL)

(72) Inventors: Ralph Kurt, Eindhoven (NL); Stefan Marcus Verbrugh, Eindhoven (NL); Jorrit Ernst De Vries, Culemborg (NL); Henricus Marius Joseph Maria Kahlman, Dongen (NL)

(73) Assignee: KONINKLIJKE PHILIPS N.V., EINDHOVEN (NL)

(21) Appl. No.: 14/124,097

(22) PCT Filed: Jun. 6, 2012
(86) PCT No.: PCT/IB12/52848

§ 371 Date: Dec. 5, 2013

(30) Foreign Application Priority Data
Jun. 10, 2011 (EP) 11169462.6

(51) Int. Cl. H05B 33/08

(52) U.S. Cl. CPC H05B 33/0869
USPC 362/555

(57) ABSTRACT

There is provided an arrangement for light balancing. The arrangement provides light balancing and robust flux feedback and comprises a light source array, a plurality of light sources arranged as a plurality of strings of individual light emitting diodes, at least one light guide structure, and at least one optical sensor. The arrangement provides feedback relating to the optical contribution for each one of the plurality of strings of individual light emitting diodes and is thereby maintaining the emitted light at a balanced level.

### FIELD OF THE INVENTION

The present invention relates to an arrangement for light balancing. More particularly the present invention relates to an arrangement for light balancing having a light source array and a light guide structure.

### BACKGROUND OF THE INVENTION

Colored light is used in many applications where scene setting and atmosphere creation is important. Examples of applications exist in the fields of theatre lighting, architecture lighting, city beautification lighting, as well as lighting for shops, hotels, restaurants, hospitals, schools, and office spaces. Today this is mostly accomplished by combining white light sources with colored filters in order to obtain desired colors.

As an alternative, systems with multi-colored LEDs can be used. Such systems are attractive because they generate the desired colors without filters. This has an efficiency advantage and, more importantly, colors can be changed by the electronics: there is no need to change filters in order to change color; all colors are directly available by combining a number LEDs of different prime colors. Having electronically regulated colors allows various automatic programming methods to be used to control the lighting system and the fact that filters are omitted results in an easier supply chain (no filters need to be removed) and color consistency (replaced filter might introduce variation). The market for these systems is quickly growing as LED performance improves.

A multi-channel LED light source having a large number of LEDs packed on a small array is often used in multi-channel, high flux LED applications and in multi-color entertainment spots (for theatre/touring/stage/studio applications). In these professional applications, color consistency between LED products, both initially and over lifetime, is a major concern and requirement. Attempts are therefore made to combine initial calibration, temperature feed-forward and optical feedback in order to obtain a robust and reliable LED light source. An example of a feedback controlled illumination system is disclosed in US 2009/0237003.

However, there is still a need for an efficient solution providing robust flux sensing and optical feedback for these types of applications.

### SUMMARY OF THE INVENTION

In view of the above it is desirable to provide an arrangement for light balancing that can provide robust flux feedback. In order to precisely measure the optical output of the system it is desired to integrate optical feedback, in or close to, the multicolor LED array. It is also desirable to make efficient use of the light that is emitted from the LEDs at a very large angle and thus only has a small probability of reaching an exit aperture of a reflector being attached to the LED array, due to the large number of reflections in the reflector. Using this particular fraction of light for sensing is therefore an efficient solution because it has a very small or negligible contribution to the spot anyway.

Further it is desirable to allow flux sensing for each individual channel. In other words, it is desirable to obtain a substantially balanced signal for each LED string, i.e., letting each color have substantially equal sensor contribution to the flux signal.

It is an objective of the current invention to provide an arrangement which solves or at least mitigates the issues addressed above.

According to a first aspect of the invention, this and other objects are achieved by an arrangement for light balancing, comprising a light source array comprising a plurality of light sources emitting light, wherein said plurality of light sources represent a plurality of individual color channels and are arranged as a plurality of strings of individual light-emitting diodes; at least one light guide structure located at the light source array such that the at least one light guide structure is arranged to collect and guide part of the light emitted by at least one of the plurality of light sources into at least one optical sensor, said part of the light comprising light emitted substantially perpendicular to an optical axis being defined as perpendicularly extending from said light source array, wherein said part of the light is excluded from light intended to enter an aperture of a reflector to be placed along said optical axis, wherein said at least one optical sensor is located at said light guide structure and capable of measuring luminous flux of the collected light, thereby to estimate an optical contribution from each one of said plurality of individual color channels; and wherein said at least one light guide structure and said at least one optical sensor further are arranged to provide feedback relating to the optical contribution for adjusting each one of said plurality of strings of individual light-emitting diodes, thereby maintaining the emitted light at a balanced level.

Advantageously such an arrangement may provide robust flux feedback for a multichannel LED light source comprising multiple integrating light guides (wave guides or fiber optics) which are positioned at a level very close to the LED array. This allows flux sensing (for each individual channel) and a substantially balanced signal for each LED string. In other words each color has substantially equal sensor contribution to the flux signal.

An arrangement according to the present invention is relatively insensitive against assembly tolerances, allowing manufacturing a robust product.

Mixing may be achieved in the light guide structure. However perfect mixing is not required as initial calibration can be stored in a module comprising the LED array as well as sensing and feedback.

An arrangement according to the present invention may advantageously be realized together with a mixing and collimating trumpet shaped reflector. The reflector may be designed for good color mixing. Hence it may be almost parallel near the entrance and may become wider near the exit. This “trumpet shape” mixes the light near the entrance through many reflections and collimates light near the exit. A consequence of this reflector shape is that light emitted from the LEDs at a very large angle only has a small probability of reaching the exit aperture of the reflector, due to the large number of reflections. The present invention is based on the fact that it is advantageous to let the sensor use this light. This optimizes use of this light that cannot contribute to the spot any way.

In an embodiment, the light guide structure may be attached to the light source array. Placement of the light guide structure close to the light source array allows precise measurement of the optical output of the arrangement, thus allowing better optical feedback.

According to a second aspect of the invention, the above object and other objects are achieved by a LED light source comprising an arrangement as disclosed above.

According to a third aspect of the invention, the above object and other objects are achieved by a luminaire, comprising an arrangement as disclosed above.

It is noted that the invention relates to all possible combinations of features recited in the claims. Thus, all features and advantages of the first aspect likewise apply to the second and third aspects, respectively.

### BRIEF DESCRIPTION OF THE DRAWINGS

The various aspects of the invention, including its particular features and advantages, will be readily understood from the following detailed description and the accompanying drawings, in which:

FIG. 1 illustrates a LED array according to an embodiment;

FIG. 2 illustrates an arrangement comprising a LED array and a tubular reflector according to an embodiment; and

FIGS. 3-6 illustrate arrangements comprising a LED array and a light guide structure according to embodiments.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled addressee. Like reference characters refer to like elements throughout.

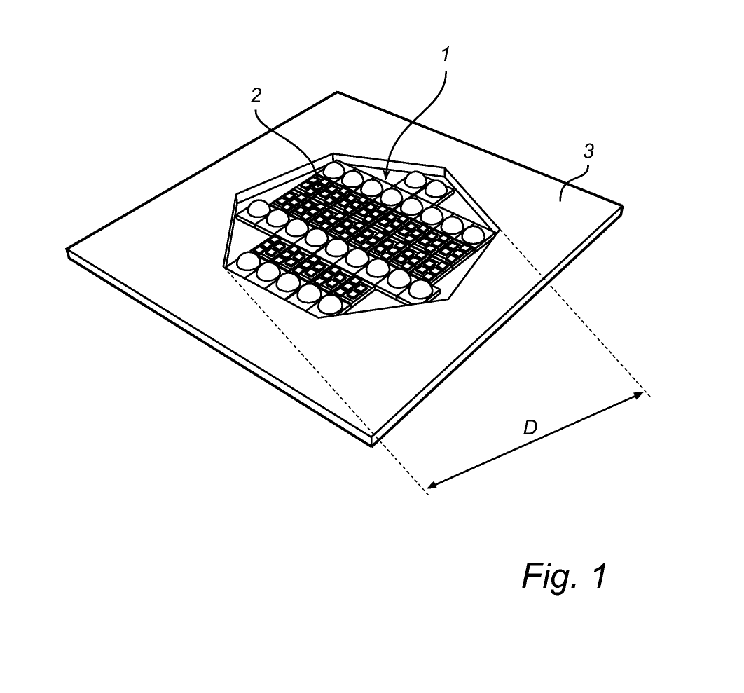

FIG. 1 illustrates a highly dense packed light source array 1. The illustrated light source array, which is attached to a substrate 3, has a diameter D of about 29 mm, comprises six color channels, and has 120 LEDs 2. One or more light source arrays 1 as illustrated in FIG. 1 may be used in an arrangement for light balancing.

According to embodiments the light source array 1 may generally comprise at least one set of light sources 2 arranged to emit light of a first color and at least one set of light sources 2 arranged to emit light of a second color different from the first color. A set of light sources 2 may be defined by a single light source. Similarly, a set of light sources 2 may comprise two or more light sources arranged together in a group. For example, a set of light sources 2 may be provided in the form of a line of light emitting diodes (LEDs). According to an embodiment the light source comprises a plurality of LEDs. Preferably the light source comprises between 5 and 250 LEDs. More preferably, the light source comprises between 20 and 200 LEDs. Even more preferably, the light source comprises between 70 and 150 LEDs. Increasing the number of light sources may increase the flux (in lm) of the outputted light. Increasing the number of light sources may also increase the number of different colors obtainable by the arrangement.

According to an embodiment of the invention, the light source comprises LEDs of 2-8 different colors. For example, the LEDs may have white (W), neutral white (NW), warm white (WW), red (R), green (G), blue (B), amber (A), cyan (C), deep red (dR) and/or deep blue (dB) emission spectrum. By combination thereof, any desired light spectrum is obtainable that falls within the color space made up by the color coordinates of the WRGBAdRdB starting LEDs. According to an embodiment the light source thus comprises a plurality of colors such as (RGB), (NW+WW), (RGBA), (RGBAW), (RGBW), (RGBAC), (RGBAdR), (RGBACdR), (RGBACdRW), (RGBACdRdB), or the like.

The light source array may have different shapes depending on, for example, the number of LEDs, the light effect to be achieved, and the type of reflector (see below) to be used with the light source array.

According to an embodiment of the invention, the light source array may have a polygonal shape with preferably four to eight facets.

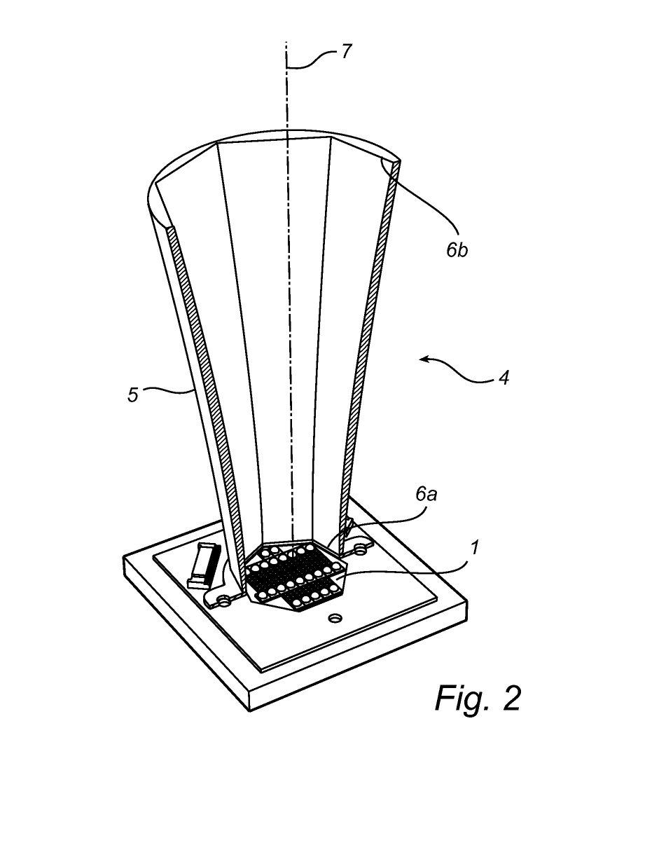

FIG. 2 is a perspective view of a high brightness LED light source based arrangement 4. The arrangement 4 comprises a highly dense packed LED array 1 and a mixing and/or collimating tubular reflector 5 (also known as a trumpet reflector). The tubular reflector 5 has an entrance aperture 6a and an exit aperture 6b. Light from the LED array 1 is received at the entrance aperture 6a and mixed and/or collimated light is emitted at the exit aperture 6b. According to the embodiment illustrated in FIG. 2 a light source array 1 comprising a plurality of light sources 2 may be arranged to emit light into the tubular reflector at the entrance aperture 6a thereof. The light source array 1 may therefore be positioned close to or adjacent to (the entrance aperture 6a of) the tubular reflector.

Further, an optical axis 7 may thus be formed from the light source array 1 towards the exit aperture 6b of the tubular reflector 5.

The tubular reflector 5 may generally have a reflective inner surface, an entrance aperture 6a and an exit aperture 6b being larger than the entrance aperture and the arrangement 4 and the tubular reflector 5 may be arranged such that light emitted from the light source array 1 enters the tubular reflector at the entrance aperture 6a and may in the tubular reflector 5 form a collimated beam of homogenous color mixed light to be outputted at the exit aperture 6b.

In general, the tubular reflector 5 may have a polygonal (preferably a rectangular, a square, a pentagonal, a hexagonal, a heptagonal, or an octagonal) cross-section or a round or elliptical cross-section. According to a preferred embodiment, the tubular reflector 5 may comprise a multifold of facets, preferably seven.

The arrangement 4 is suitable for light balancing in applications for spot illumination. As discussed earlier it is desirable to achieve a robust and reliable LED light source in these types of applications. Combination of different factors such as initial calibration, temperature feed-forward, and optical feedback in a smart way may lead to a robust and reliable LED light source.

However, a consequence of the shape of the tubular reflector is that there is a particular fraction of the light being emitted from the LED array at a very large angle that, due to the large number of reflections in the reflector, only has a small possibility of reaching the exit aperture of the reflector.

To solve the problems discussed above and to improve the optical feedback of this arrangement it has been discovered that an efficient solution is to provide the LED array with a light guide structure. The light guide structure may comprise multiple integrating wave guide structures of fiber optics. Such a light guide structure allows flux sensing for each individual channel and provides a substantially balanced signal for each LED string. In other words, each color has substantially equal sensor contribution to the flux signal.

The light guide structure may be attached to the entrance aperture of the tubular reflector.

Modularity may be achieved in that the LED array may be combined with other collimation or mixing optics.

In particular, this arrangement has been demonstrated to work well with LED arrays comprising a large number of LEDs (4-50) per color channel and where differential ageing has been strongly simulated. An example of differential ageing is the combination of red LEDs with blue, green, and white LEDs. Red LEDs age much faster than the others and if this is not compensated for, by adjusting the currents or duty cycles, the colors of an old source will look different from a new source, although the same control input is given.

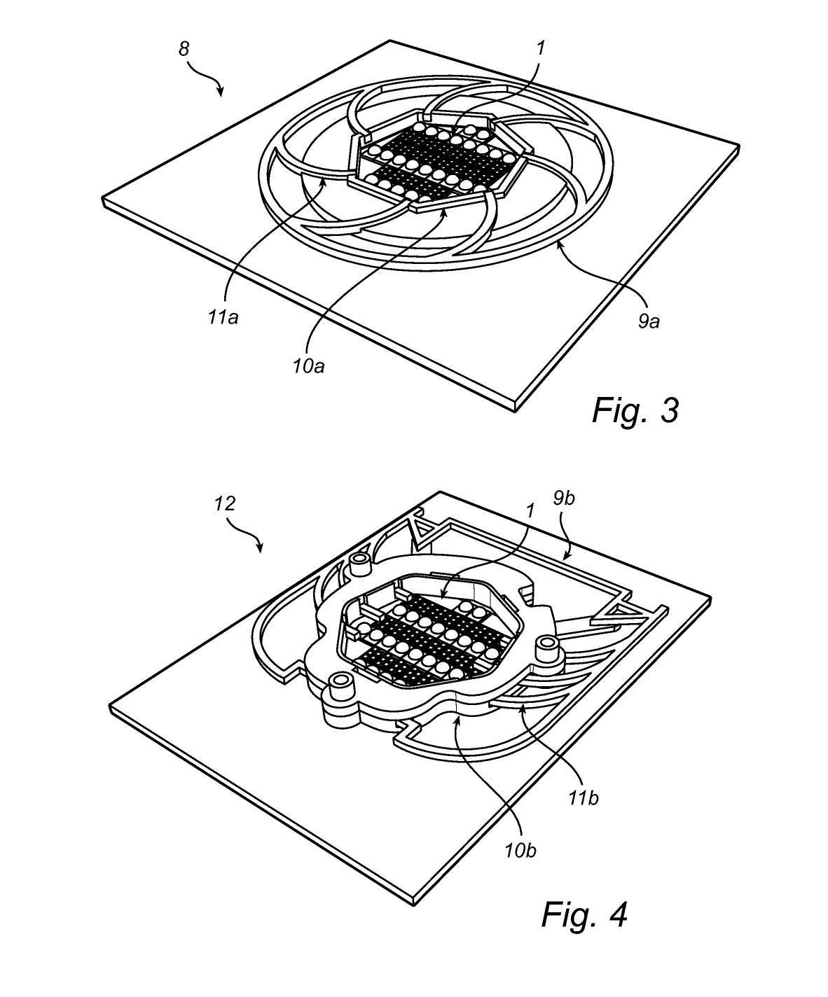

FIG. 3 illustrates such an arrangement 8. The arrangement 8 comprises a light source array land a light guide structure 9a according to an embodiment. As described above in relation to FIG. 1, the arrangement 8 may in general comprise a light source array comprising a plurality of light sources emitting light. The plurality of light sources may represent a plurality of individual color channels and may be arranged as a plurality of strings of individual light-emitting diodes.

The arrangement 8 may comprise at least one light guide structure 9a located at the light source array 1 such that the at least one light guide structure 9a is arranged to collect and guide part of the light emitted by at least one of the plurality of light sources into at least one optical sensor (not shown). As noted above, this part of the light may comprise light emitted substantially perpendicular to an optical axis being defined as perpendicularly extending from the light source array. This part of the light is excluded from light intended to enter an aperture of a reflector (for example the reflector 5, as disclosed above) to be placed along the optical axis, wherein the at least one optical sensor may be located at the light guide structure 9a and capable of measuring luminous flux of the collected light, thereby to estimate an optical contribution from each one of the plurality of individual color channels. The at least one light guide structure 9a and the at least one optical sensor may further be arranged to provide feedback relating to the optical contribution for adjusting each one of the plurality of strings of individual light-emitting diodes, thereby maintaining the emitted light at a balanced level.

In general, the light guide structure 9a may have many different shapes and may integrate light from different LEDs into collection means to which flux sensors are attached. Generally, the light guide structure 9a may comprise a spacer ring 10a and an integrating waveguide structure (ring) for balanced optical feedback. The spacer ring 10a may serve as mechanical and optical interface between the LED array and the mixing/collimation optics. In general, multiple light feed probes may in various ways extend from the spacer ring and flux sensors may be placed on the outer ring and may sense the light contribution of each LED string. The flux sensors may be photo diodes. This arrangement allows for the possibility of calculating the contribution of the light coupled in the light guide structure from different LED positions in the LED array. This can be achieved by dividing the LED array into rows and columns, thereby generating different positions. The light contribution from each position and each color is separately calculated.

The light guide structure 9a in FIG. 3 has a plurality of light feed probes, one of which is denoted by reference numeral 11a, and which may be arranged in a circular shape. More specifically, the light feed probes may be arranged in a vortex shape. In this manner, the light feed probes may be given a relatively long length, without making the arrangement bulkier.

The at least one light guide structure 9a may be attached to the light source array. This allows the light feed probes to be located very close to the LED array, which is advantageous for the present invention as it improves robustness of the arrangement.

The flux sensing described above may be operated in a time sequential mode, e.g. at high frequency. Further, it may be sufficient to apply optical feedback at limited times per week of day, e.g. only at start-up of the system.

In a preferred embodiment, the contribution of each individual LED (in a string) may be measured. Such a detailed measurement of contribution from each individual LED may result in a well averaged color flux signal.

The at least one light guide structure may comprise transmissive parts belonging to at least one from the group comprising transmissive glass and/or transmissive polymeric material, the transmissive polymeric material being one from PET, PMMA, polycarbonate, cyclic olefin copolymer (COC), polystyrene (PS), polysulfone, polyamide, polyetherimide (PEI), polymethacrylmethylimid (PMMI), styrol-acryl-nitril (SAN), acrylnitril-butadien-styrolcopolymere (ABS), polyphenylsulfone (PPSU), and polyethersulofone (PES).

The at least one light guide structure may belong to at least one from the group comprising wave guides, optical fibers, TIR optics, and reflective light channels.

In an embodiment, the arrangement may further comprise a substantially transparent material disposed on the light source array. The transparent material may be in contact with at least a portion of the at least one light guide structure. This material acts as an encapsulant for protection of the LEDs and wire bonds, but can also enhance light out coupling from the LEDs. This transparent material preferably has a lens or multiple micro lens shapes. In order to realize a robust arrangement, it may be preferred to apply a transparent protection layer on top of the LED array or at least parts of it. The components (LEDs) and wire bonds may be protected against moisture, contamination and unintended damage. This may be realized by suspension of silicon (like glob top), by over molding or by under fill techniques.

According to a preferred embodiment, the transparent material may be adjacent or in optical contact with at least a portion of the entrance windows of the transparent light or wave guide structures.

Each one of the multiple light feed probes may be located at a position corresponding to a respective one of the facets of the light source array.

An end facet of the light feed probes may be angled 45° in relation to a main body of the light feed probe, such that light is coupled out substantially perpendicularly to the main body. In this manner, light is directed particularly efficiently towards a photodiode or another light sensor. In this way the sensor can be arranged substantially parallel to the LED array, according to one embodiment even in the same plane or even at the same board as the LEDs. According to another embodiment the sensor can be placed on a board different but parallel to the LED board.

Similarly, an entrance facet of the light feed probes may be angled towards the LEDs in order to increase light incoupling.

An optical link may be formed between the end facet of the light feed probe and the sensor, e.g., by optical glue, silicone, etc.

FIG. 4 illustrates an arrangement 12 according to an embodiment comprising a light source array 1, a light guide structure 9b, and a spacer ring 10b. The light guide structure 9b in FIG. 4 has a plurality of light feed probes, one of which is denoted by reference numeral 11b. The light feed probes have the same function according to what has been described above and may be arranged extending from the spacer ring in the illustrated shape.

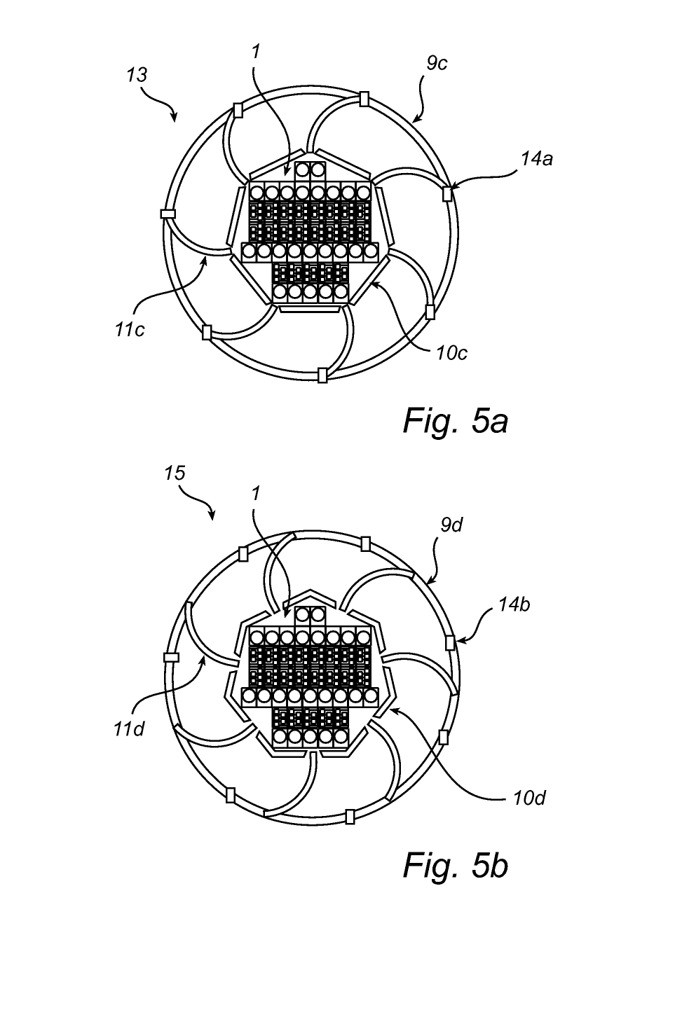

FIG. 5a illustrates an arrangement 13 according to an embodiment comprising a light source array 1, a light guide structure 9c, and a spacer ring 10c. The light guide structure 9c in FIG. 5a has a plurality of light feed probes, one of which is denoted by reference numeral 11c. The light guide structure 9c further has a plurality of optical sensors, one of which is denoted by reference numeral 14a. The light feed probes have the same function according to what has been described above and may be arranged extending from each corner of the heptagonally shaped spacer ring.

According to another alternative, FIG. 5b illustrates an arrangement 15, being similar to the arrangement 13 of FIG. 5a. The arrangement 15 comprises a light source array 1, a light guide structure 9d, and a spacer ring 10d. The light guide structure 9d in FIG. 5b has a plurality of light feed probes, one of which is denoted by reference numeral 11d. The light guide structure 9d further has a plurality of optical sensors, one of which is denoted by reference numeral 14b. The light feed probes have the same function according to what has been described above and may be arranged extending from each facet of the heptagonally shaped spacer ring.

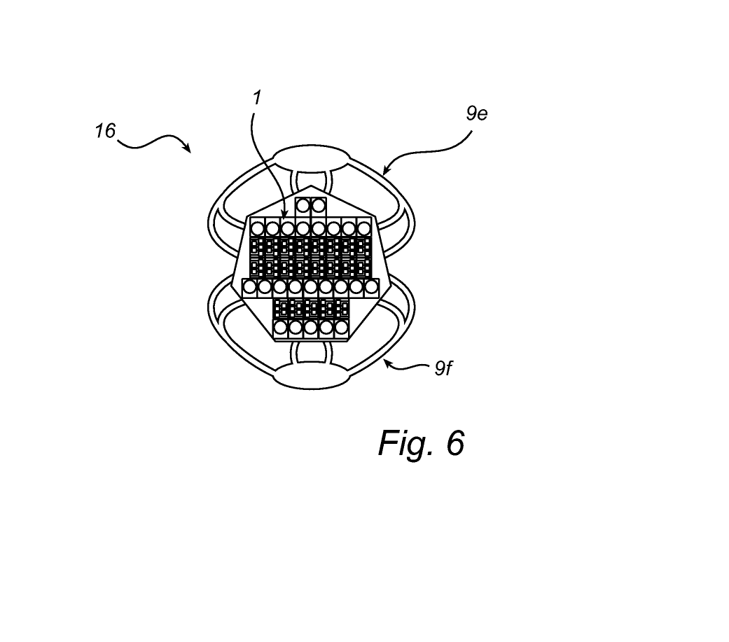

FIG. 6 illustrates an arrangement 16 according to yet another embodiment comprising a light source array 1, an upper light guide structure 9e, and a lower light guide structure 9f. The function of the light source array 1 and the light guide structures 9e, 9f has been discussed above in relation to FIG. 3 and works in a similar way.

In summary there has been disclosed an arrangement for light balancing. The arrangement comprises a light source array comprising a plurality of light sources arranged to emit light (preferably of different spectral content and/or different colors) into a tubular reflector. The system further comprises at least one light guide structure and at least one optical sensor. The light source array, the light guide structure, and the optical sensor are arranged to provide optical feedback and maintaining the emitted light at a balanced level.

The person skilled in the art realizes that the present invention by no means is limited to the preferred embodiments described above. On the contrary, many modifications and variations are possible within the scope of the appended claims. For example, the disclosed arrangement may be part of a LED light source. Thus, a LED light source may comprise one or more arrangements as disclosed above. Similarly, the disclosed arrangement may be part of a luminaire.

1. An arrangement for light balancing, comprising
a light source array comprising a plurality of light sources emitting light, wherein said plurality of light sources represent a plurality of individual color channels and are arranged as a plurality of strings of individual light-emitting diodes;
at least one light guide structure located at the light source array such that the at least one light guide structure is arranged to collect and guide part of the light emitted by at least one of the plurality of light sources into at least one optical sensor, said part of the light comprising light emitted substantially perpendicular to an optical axis being defined as perpendicularly extending from said light source array, and
a tubular reflector disposed along said optical axis,
wherein said part of the light is excluded from light intended to enter an aperture of said tubular reflector,
wherein said at least one optical sensor is located at said light guide structure and capable of measuring luminous flux of the collected light, thereby to estimate an optical contribution from each one of said plurality of individual color channels; and
wherein said at least one light guide structure and said at least one optical sensor further are arranged to provide feedback relating to the optical contribution for adjusting each one of said plurality of strings of individual light-emitting diodes, thereby maintaining the emitted light at a balanced level.

2. The arrangement according to claim 1, wherein said light guide structure is attached to an entrance aperature of said tubular reflector.

3. The arrangement according to claim 1, said tubular reflector has a reflective inner surface and an exit aperture being larger than said entrance aperture, said arrangement and said tubular reflector being arranged such that light emitted from the light source array enters said tubular reflector at said entrance aperture and in said tubular reflector forms a collimated beam of homogenous color mixed light to be outputted at said exit aperture.

4. (canceled)

5. The arrangement according to claim 1, wherein said light guide structure is attached to said light source array.

6. The arrangement according to claim 1, wherein said light source array has a polygonal shape.

7. The arrangement according to claim 1, wherein said at least one light guide structure comprises multiple light feed probes arranged in a circular shape.

8. The arrangement according to claim 7, wherein said light source array has a polygonal shape with a plurality of facets and each one of said multiple light feed probes is located at a position corresponding to a respective one of said facets of said light source array.

9. The arrangement according to claim 7, wherein said light feed probes are arranged in a vortex shape.

10. The arrangement according to claim 1, wherein said at least one light guide structure comprises transmissive parts selected from the group consisting of: transmissive glass and/or transmissive polymeric material, the transmissive polymeric material being one from PET, PMMA, and polycarbonate.

11. The arrangement according to claim 1, wherein said at least one light guide structure is selected from the group consisting of: wave guides, optical fibers, total internal reflection optics, and reflective light channels.

12. The arrangement according to claim 1, further comprising a substantially transparent material disposed on said light source array, wherein said transparent material is in contact with at least a portion of said at least one light guide structure.

13. The arrangement according to claim 1, wherein said plurality of light sources comprises at least one set of light sources arranged to emit light of a first color arid at least one set of light sources arranged to emit light of a second color different from said first color.

14-15. (canceled)
